(19) United States
(12) Patent Application Publication
(10) Pub. No.: US 2008/0115046 A1
(43) Pub. Date: May 15, 2008

(54) PROGRAM, COPY AND PASTE PROCESSING METHOD, APPARATUS, AND STORAGE MEDIUM

(75) Inventor: Aya Yamaguchi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/843,016

(22) Filed: Aug. 22, 2007

(30) Foreign Application Priority Data
Nov. 15, 2006 (JP) 2006-308674

(51) Int. Cl. G06F 15/00

(52) U.S. Cl. 715/201

(57) ABSTRACT

A document storage unit stores, as a type of a document element in a document, an element sequence in which a text element which is a document element for text and an image element which has a server character image acquired from the server as a view, has a character code value as an attribute, and is dependent on a platform are mixed. When a copy operation on a screen is determined, a copy processing unit reads character codes from the text element and the image element stored in the document of a copy source, generates copy source character sequence data, and stores the data in a copy buffer. When a paste operation is determined subsequent to the copy operation, a paste processing unit generates an element sequence including the text element and the image element from the copy source character sequence data stored in the copy buffer, and inserts the sequence to a document of a paste destination. In this course, the character image of the image element is acquired from the server.

This application is a priority based on prior application No. JP 2006-308674, filed Nov. 15, 2006 in Japan.

### BACKGROUND OF THE INVENTION

1. Field of the Invention

The present invention relates to a program, copy and paste processing method and apparatus, and a storage medium for copy and paste in editing of a document in which a web page of a server is opened by a browser of a client and, in particular, relates to a program, character input editing method and apparatus, and a storage medium for copy and paste in editing of a document in which a character image acquired from a server is mixed with text.

2. Description of the Related Arts

Conventionally, when character input is to be performed from a client with respect to an application provided by a server, the character input is performed by a character input program provided by an OS of the client, for example, kana/kanji conversion program IME (R) in Japanese-supporting Windows (R). When the application uses a character code system different from that of the OS of the client as operating character codes, a character input program corresponding to the operating character codes have to be distributed to the client in advance together with a word dictionary and a font file. However, in a character input editing system which distributes the character input programs of operating character codes to clients together with word dictionaries and font files, a task of distributing the character input programs and the word dictionaries to the clients by FTP, public files, or manual operations is required in a building stage of the system; and, furthermore, when there is correction of font data, addition of extended characters, etc. during operation, data has to be distributed to all the clients in every case thereof; therefore, operation cost is taken. When extended characters, vendor-dependent characters, etc. are subjected to character input by the clients, special applications have to be used. Therefore, when the system is to be started up, the applications have to be set up in all the clients in advance; thus, high initial cost is taken. When an English-supporting OS is used as the OS of the client like that of overseas, input by Japanese cannot be performed; therefore, Japanese-supporting business applications provided by the server cannot be utilized. In order to solve this problem, a system which is configured so that, when a web page of a server is opened by using browsers of clients, character input programs are transferred to the clients at the same time as character inputting web pages so as to realize kana input functions, and all the functions other than the kana input functions, i.e., kana/kanji conversion functions including word dictionary conversion functions, conversion functions of all or partial font images including extended characters, and code system conversion functions are processed in the server side has been proposed (JP 2004-252944). According to this system, distribution of data such as character input/output programs, dictionaries, and font files to the clients is not required in advance at all, and setup operations with respect to the clients upon initial installation is not required at all. Moreover, even when the client side has an English-supporting OS not having the function of Japanese character input, by accessing the web page of the server of this invention merely by the browser of the client, an advantage that, for example, Japanese input can be realized even by the client having an OS supporting any language can be obtained.
[Patent Document 1] Japanese Patent Application Laid-Open (kokai) No. 2004-252944

However, in such a conventional system, as a font conversion function in the server, either one of operating modes,
(1) a hybrid off mode in which all character codes are subjected to font conversion into character images and
(2) a hybrid on mode in which part of character codes such as extended characters is subjected to font conversion into character images, and those other than that undergo font conversion into character images in the clients, is set upon system start-up so that it can be fixedly operated; however, there are following problems regarding a copy process which is performed as one of editing operations. First of all, in the hybrid off mode, a displayed kana/kanji conversion character sequence cannot be copied to another location. Specifically, when the kana/kanji conversion character sequence displayed in the client is to be copied to another location by a copy and paste operation, the displayed kana/kanji character sequence is merely image data; and, even when it is stored, for example, in a copy buffer of a clipboard by a copy operation, a character code thereof cannot be obtained since it is not generated by the font conversion function of the client, blank data merely indicating presence of characters is merely provided, and a copy process cannot be performed. In the hybrid on mode, for example when an extended character is present, a mixed character sequence (hybrid character sequence) of a server image character and an image character, which is generated in the client, is provided; and, even when this is stored in a clipboard and a copy buffer by a copy operation, the server image character is not converted into a character code, blank data merely indicating presence of characters is provided, character missing occurs, and there is a problem that copying cannot be correctly performed.

### SUMMARY OF THE INVENTION

According to the present invention to provide a program, copy and paste processing method and apparatus, and a storage medium which enable correct copy and paste even when a character image generated by the font conversion function of the server and a character image generated by the font conversion function of the client are mixed.

(Program)

The present invention provides a program executed by a computer of a client connected to a server via a network.

The program of the present invention is characterized by causing the computer of the client to execute

a document storage step in which, as a type of an element sequence, an element sequence in which a text element which is an element sequence for text and an image element which has a server character image acquired from the server as a view and has a character code value as an attribute are mixed is stored in a document;

a copy processing step in which, when a copy operation is determined on a screen, character codes are read from the text element and the image element stored in the document of a copy source, and copy source character sequence data is generated and stored in a copy buffer; and

a paste processing step in which, when a paste operation is determined subsequent to the copy operation, an element sequence including the text element and the image element is generated from the copy source character sequence data stored in the copy buffer and inserted into a document of a paste destination.

The paste processing step causes the computer of the client to execute

a character form display processing step in which character form display method definition information registered in advance is referenced for each character code of the copy source character sequence stored in the copy buffer, a text element in which the character code serves as a code value without change is generated when client font display is determined, and an image element in which a sever character image acquired by transmitting a character image request signal including the character code to the server is disposed in a view and a character code value is provided as an attribute is generated when server image display is determined; and

a paste storage step in which an element stream in which the text element and the image element generated in the character form display processing step are mixed is stored in the document of the paste destination.

The character form display method definition information and a program which executes the character form display processing step are downloaded from the server and executed by the client.

The text element and the image element have a data structure dependent on a platform in which the document is present. The character code is, for example, a unicode.

(Method)

The present invention provides a copy and paste processing method of a client connected to a server via a network. The copy and paste processing method of the present invention is characterized by executing

a document storage step in which, as a type of an element sequence, an element sequence in which a text element which is an element sequence for text and an image element which has a server character image acquired from the server as a view and has a character code value as an attribute are mixed is stored in a document;

a copy processing step in which, when a copy operation is determined on a screen, character codes are read from the text element and the image element stored in the document of a copy source, and copy source character sequence data is generated and stored in a copy buffer; and

a paste processing step in which, when a paste operation is determined subsequent to the copy operation, an element sequence including the text element and the image element is generated from the copy source character sequence data stored in the copy buffer and inserted into a document of a paste destination.

(Apparatus)

The present invention provides a copy and paste processing apparatus provided in a client connected to a server via a network. The copy and paste processing device of the present invention is characterized by having

a document storage unit which, as a type of an element sequence, stores an element sequence in which a text element which is an element sequence for text and an image element which has a server character image acquired from the server as a view and has a character code value as an attribute are mixed in a document;

a copy processing unit which, when a copy operation is determined on a screen, reads character codes from the text element and the image element stored in the document of a copy source, generates copy source character sequence data, and stores the data in a copy buffer; and

a paste processing unit which, when a paste operation is determined subsequent to the copy operation, generates an element sequence including the text element and the image element from the copy source character sequence data stored in the copy buffer and inserts the sequence into a document of a paste destination.

According to the present invention described above, even when a character image generated by a font conversion function of a server and a character image generated by a font conversion function of a client are mixed in a document, specifically, even when, as a type of an element sequence, a document stores an element sequence in which a text element which is an element sequence for text and an image element which has a server character image acquired from the server as a view and has a character code value as an attribute are mixed, by a copy and paste operation, a character sequence code can be generated from the element sequence in which the text element and the image element are mixed, and the element sequence in which the text element and the image element are mixed can be generated again from the character sequence code and stored in a document of a paste destination via a copy buffer; and, even when it is an image element, copy and paste can be correctly performed by imparting the character code attribute thereto without losing the character corresponding to the image element, and an editing operation of the document can be appropriately performed. The above and other objects, features, and advantages of the present invention will become more apparent from the following detailed description with reference to the drawings.

### BRIEF DESCRIPTION OF THE DRAWINGS

FIG. 1 is a block diagram showing, together with an embodiment of a functional configuration of a server, a system environment to which he present invention is applied;

FIG. 2 is a block diagram of hardware resources of a computer used as the server and client of FIG. 1;

FIGS. 3A and 3B are explanatory diagrams of the kana/kanji conversion dictionary and font file provided in the server of FIG. 1;

FIG. 4 is an explanatory diagram of a web page opened by a browser of a client;

FIG. 5 is an explanatory diagram of attribute information set in the web page;

FIG. 6 is a block diagram of a display/UI engine according to the present embodiment realized by execution of a program downloaded from the server to the client;

FIG. 7 is an explanatory diagram of the character form display method definition file of FIG. 1;

FIGS. 8A and 8B are explanatory diagrams of input area selection and a candidate window of the web page;

FIG. 9 is an explanatory diagram of a kana conversion process in the browser of the client;

FIGS. 10A and 10B are time charts of a character input editing process according to the present embodiment by the client and the server;

FIGS. 11A to 11E are explanatory diagrams showing, by data structures, transition until display data is generated from reading information in the present embodiment;

FIG. 12 is a flow chart of server process of the present embodiment;

FIGS. 13A and 13B are flow charts of the client process according to the present embodiment;

FIG. 13C is a flow chart of the client process subsequent to FIGS. 13A and 13B;

FIG. 14 is a block diagram of a functional configuration of a copy and paste process according to the present embodiment;

FIGS. 15A to 15F are explanatory diagrams showing transition of data in the copy and paste process of the present embodiment; and

FIGS. 16A and 16B are flow charts of the copy and paste process of the present embodiment.

### DETAILED DESCRIPTION OF THE PREFERRED EMBODIMENTS

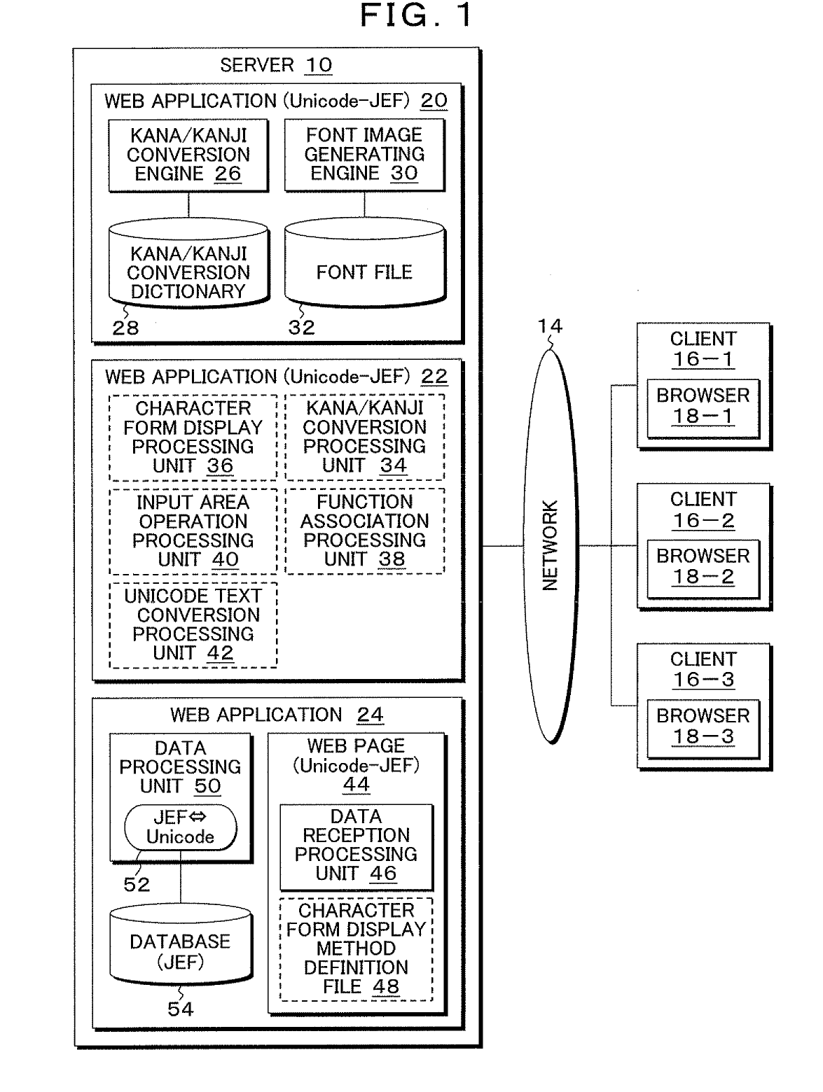

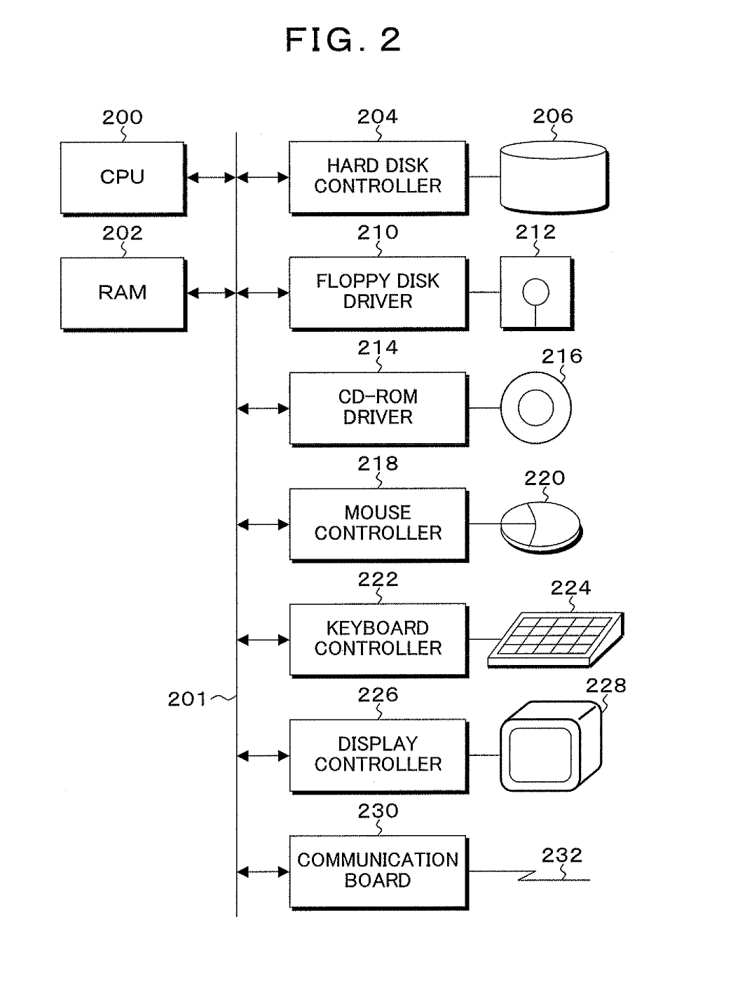

FIG. 1 is a block diagram of a system configuration to which a character input editing process of the present invention by a Japanese-supporting server is applied. In FIG. 1, clients 16-1, 16-2, and 16-3 are connected to the server 10 via a network 14. In the server 10, three web applications 20, 22, and 24 are provided. In the clients 16-1 to 16-3, browsers 18-1 to 18-3 are provided. The web application 20 of the server 10 is a web application group which performs search of a dictionary or images and is provided with a kana/kanji conversion engine 26, a kana/kanji conversion dictionary 28, a font image generating engine 30, and a font file 32. The web application 22 is a web application group which generates and transmits display/UI engines (client execution programs of JavaScript) to be downloaded to and operated in the clients 16-1 to 16-3, and a program which realizes the functions of a kana/kanji conversion processing unit 34, a character form display processing unit 36, a function association processing unit 38, an input area operation processing unit 40, and a Unicode text conversion processing unit 42 is disposed. The web application 24 is a web application group of a user such as a SE, wherein, for example, a database 54 controlled by a data processing unit 50 is present, and a web page 44 for updating the database 54 by the character input editing process of the present embodiment is provided. The web page 44 is utilized in the client side in association with the function of the display/UI engine downloaded from the web application 22 when an API of the web application 22 is invoked, and a character form display definition file 48 is downloaded to the client side. In the web page 44, a data reception processing unit 46 which receives contents of document, which has undergone a character input editing process, and passes that to the data processing unit 50 is provided. Herein, the kana/kanji conversion processing unit 34, the character form display processing unit 36, the function association processing unit 38, the input area operation processing unit 40, and the Unicode text conversion processing unit 42 of the web application 22 and the character form display method definition file 48 of the web application 24 are shown by dotted lines since they are downloaded to and executed in the client side. In the description below, the clients 16-1 to 16-3 and the browsers 18-1 to 18-3 will be described simply as clients 16 and browsers 18. The server 10 of the present invention in FIG. 1 is realized, for example, by the hardware resources of a computer like that of FIG. 2. In the computer of FIG. 2, a RAM 202, a hard disk controller (software) 204, a floppy disk driver (software) 210, a CD-ROM driver (software) 214, a mouse controller 218, a keyboard controller 222, a display controller 226, and a communication board 230 are connected to a bus 201 of a CPU 200. The hard disk controller 204 is connected to a hard disk drive 206, wherein a program of the web application which executes the character input editing process of the present invention is loaded; and, upon start-up of the computer, necessary programs are invoked from the hard disk drive 206, deployed onto the RAM 202, and executed by the CPU 200. A floppy disk drive (hardware) 212 is connected to the floppy disk driver 210, and read/write with respect to a floppy disk (R) can be performed. With respect to the CD-ROM driver 214, a CD drive (hardware) 216 is connected, and data and programs stored in a CD can be read. The mouse controller 218 transmits input operations of a mouse 220 to the CPU 200. The keyboard controller 222 transmits input operations of a keyboard 224 to the CPU 200. The display controller 226 performs display with respect to a display unit 228. The communication board 230 uses a communication line 232 including wireless transmission and performs communication with another computer or server via a network such as the Internet. Note that the clients 16-1 to 16-3 of FIG. 1 are also realized by hardware resources of a computer similar to that of FIG. 2. Furthermore, a recording medium in which the application program which executes the character input editing process of the present invention is recorded is provided. Examples of the recording medium include portable type storage media such as a CD-ROM, a floppy disk FD, a DVD disk, a magneto-optical disk, and an IC card; storage apparatuses such as hard disk HDDs provided inside/outside a computer; a database retaining programs via a line; another computer system PC and a database thereof; and an online transmission medium.

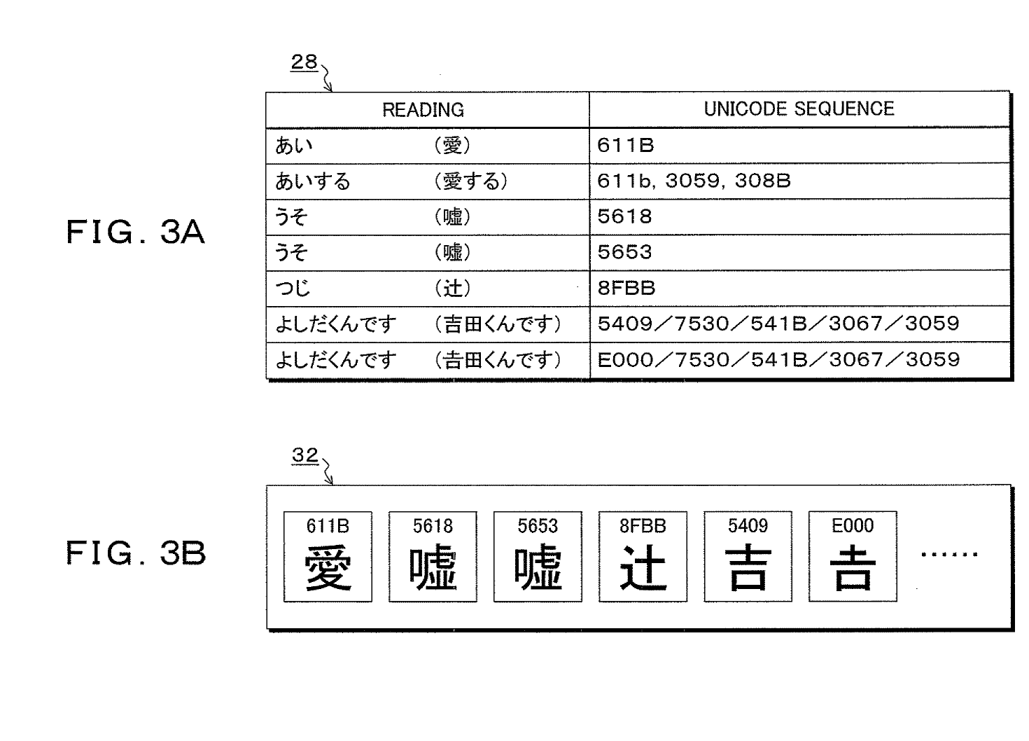

FIG. 3A is an explanatory diagram of the kana/kanji conversion dictionary 28 provided in the web application 20 of the server 10 of FIG. 1. The kana/kanji conversion dictionary 28 is comprised of readings and Unicode sequences.

FIG. 3B is an explanatory diagram of the font file 32 provided in the web application 20 of the server 10 of FIG. 1, wherein the data necessary for generating character images corresponding to all the character of Unicode is stored in combination with Unicode. In practice, instead of deployed images, data necessary for deployment is stored. Therefore, when a URL request, which is a character image request signal specifying Unicode, is received from the client 16, the font image generating engine 30 can acquire the corresponding character image by performing search in the font file 32 according to Unicode and generates, for example, a bitmap character image of the PNG format, a vector character image, or the like.

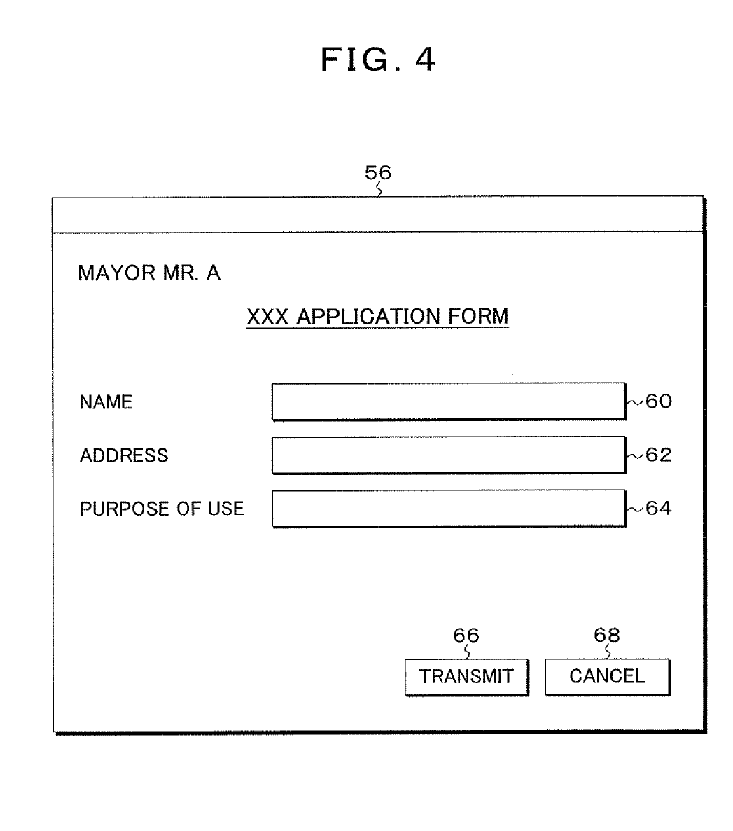

FIG. 4 is an explanatory diagram of a web page 56 according to an HTML form which is displayed when the web page 44 of the server 10 is opened by the browser 18 of the client 16. In FIG. 4, the web page 56 is for example “XXX APPLICATION FORM”, has input areas 60, 62, and 64 of a name, an address, and a purpose of use, and further provided with a transmission button 66 and a cancel button 68. Attribution information can be set in advance in each of the input areas 60, 62, and 64 in the web page 56. Note that, regarding the application web page of the character input, other than the HTML platform, below web plug-in modules may be used.
ActiveX control
ASP (Active Server Page)
Java applet
PDF form, etc.

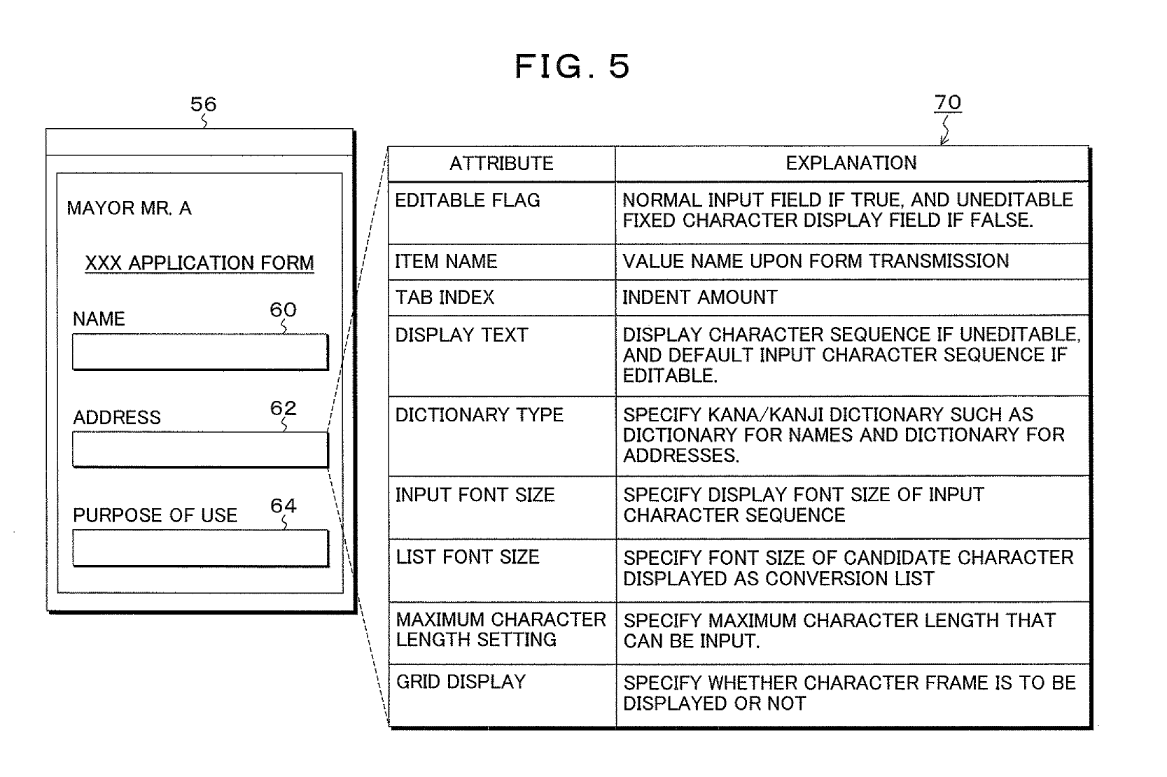

FIG. 5 is an explanatory diagram of the attribute information set in the input areas. In FIG. 5, the attribute information 70 set in the input area 62 of the address of the web page 56 is extracted, and the explanations thereof are shown. As the attributes which can be set in the input area 62,
(1) an editable flag,
(2) an item name,
(3) a tab index,
(4) display text,
(5) a dictionary type,
(6) an input font size,
(7) a list font size,
(8) maximum character length setting, and
(9) grid display can be set, and they respectively have the substances shown in the right side explanations. Note that, the following items can be also set for the attribute information of the input area.
(a) Attribute of position effective characters of a used dictionary on a network Size (height, width), color, shape (italic face, emphasis, etc.), (superscript, subscript, etc.), and font face (Mincho, Gothic, etc.).
(b) Attribute of the characters of candidate kanji Size (height, width), color, shape (italic face, emphasis, etc.), (superscript, subscript, etc.), and font face (Mincho, Gothic, etc.).
(c) Attribute of the characters of selected kanji Size (height, width), color, shape (italic face, emphasis, etc.), (superscript, subscript, etc.), and font face (Mincho, Gothic, etc.).
(d) Attribute of input form shape Size, color, image to be displayed in the background, etc.
(e) Operation attribute of input form The number of imputable characters, imputable character limiting specification (e.g., merely hiragana), etc.
(f) Attribute of selected window shape Size, color, image to be displayed in the background, etc.

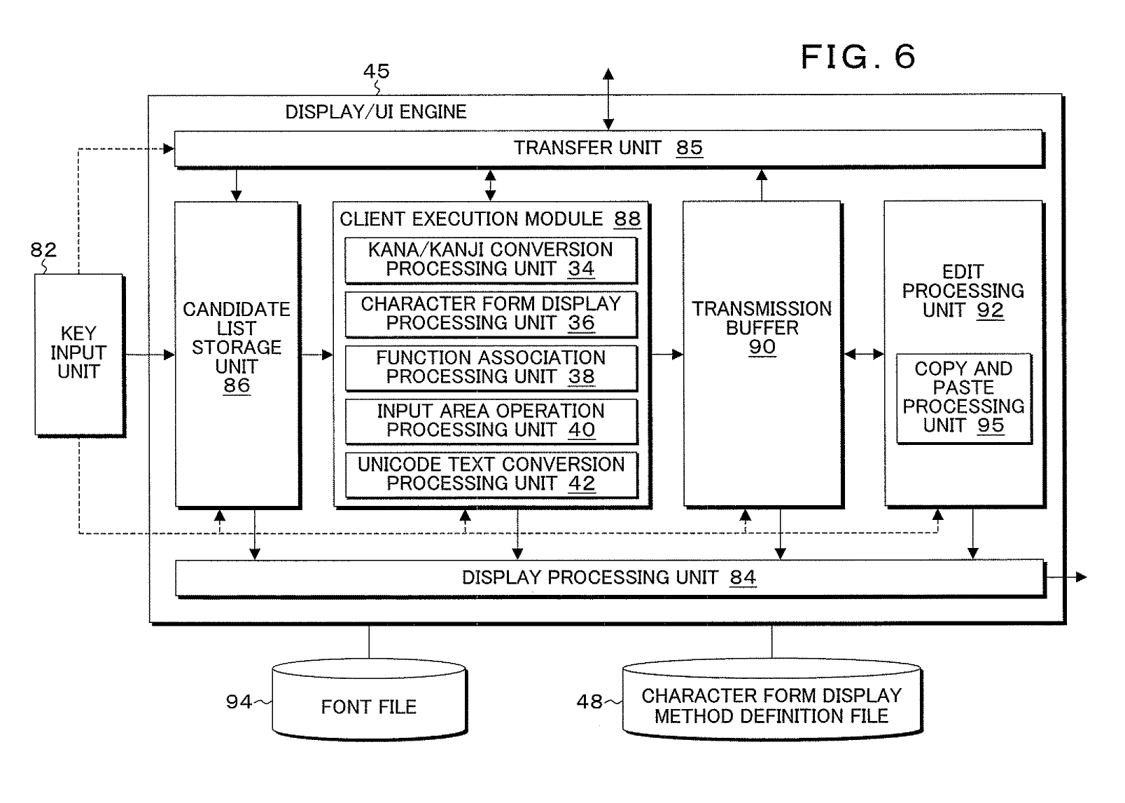

FIG. 6 is a block diagram of a functional configuration of the display/UI engine 45 which is realized by the client execution program downloaded from the server 10 to the browser 18 of the client. When the web page 44 of the web application 24 of the server 10 is opened by the browser 18 of the client 16, the web application 24 of the server 10 sends back the web page 44 including HTML and images. In the HTML, the function association processing unit 38 of the web application 22 and the character form display method definition file 48 of the web application 24 are linked. Moreover, in accordance with the specification of the platform of the HTML, corresponding to the data processing unit 50 which serves as a data transmission destination, the data reception processing unit 46 is set in the web application 24. The browser 18 of the client 16 analyzes the HTML and downloads the linked images and the client execution program of the second web application 22 from the server 10. As a result, the functions of the display/UI engine shown in FIG. 6 are built in the client 16 side. The display/UI engine 45 has a display processing unit 84, a transfer unit 85, a candidate list storage unit 86, a client execution module 88, a transmission buffer 90, and an edit processing unit 92; wherein the client execution module 88 is the function downloaded from the server 10 and includes the kana/kanji conversion processing unit 34, the character form display processing unit 36, the function association processing unit 38, the input area operation processing unit 40, and the Unicode text conversion processing unit 42. In addition, with respect to the display/UI engine 45, a key input unit 82 and the character form display method definition file 48 downloaded from the web application 24 of the server 10 are provided. When the browser 18 of the client 16 finishes interpreting all the resources (including link resources) downloaded from the server 10, the downloaded client execution module 88 attains an operatable state in the client 16. The kana/kanji conversion processing unit 34 transmits the reading information (kana information) of a character sequence, which is input in the input area of the platform of the HTML by keys, to the server 10 together with a dictionary type, receives a candidate list of kana/kanji conversion candidates, which are generated by searching the kana/kanji conversion dictionary 28 by the kana/kanji conversion engine 26 of the server, displays it in a list window with a select function and a determination function, and generates a Unicode character sequence from the selection candidates along with a select operation and a determination operation of the candidate. When the candidate list is displayed by the kana/kanji conversion processing unit 34, the character form display processing unit 36 references the character form display method definition file 48 which is associated by the function association processing unit 38, determines whether the Unicode of each candidate is to be subjected to server image display or client font display, and, in the case of the server image display, acquires a character image by the font image generating engine (character image generating unit) 30 so as to generate and display display data mixed with text. Herein, the display data of the present embodiment of the acquired character image mixed with the text is an element sequence in which a text element, which is a document element for text dependent on the HTML platform, and an image element, which has server character images acquired from the server 10 in a view and is a document element having a character code as an attribute and dependent on the HTML platform, are mixed. In other words, the display data of the present embodiment is the data in which a text element and an image element having a character code attribute are mixed. Then, when the text element is passed to a character sequence insertion API of an editor provided by the HTML platform of the client 16, character images are generated from the font file 94 of the client and displayed, and the image element displays the character images of the view without change. The input area operation processing unit 40 generates the display data, in which the image element acquired from the server by the character form display processing unit 36 and the text element are mixed, from a Unicode character sequence of the selected candidate, which is selected and determined by the kana/kanji conversion processing unit 34, and displays it in an input position of the input area. When input of the input area is finished, the Unicode text conversion processing unit 42 generates a Unicode character sequence from the display data of all the character sequence of the input area and stores that in the transmission buffer 90. Particularly, a copy and paste processing unit 95 is provided in the edit processing unit 92 of the present embodiment, wherein, when an already input character sequence is to be copied on the web page, a special copy process is performed so that an image element is not lost even when the display data of this mixed element is copied and pasted since the character sequence display data serving as a copy object is an element sequence in which an image element and a text element are mixed.

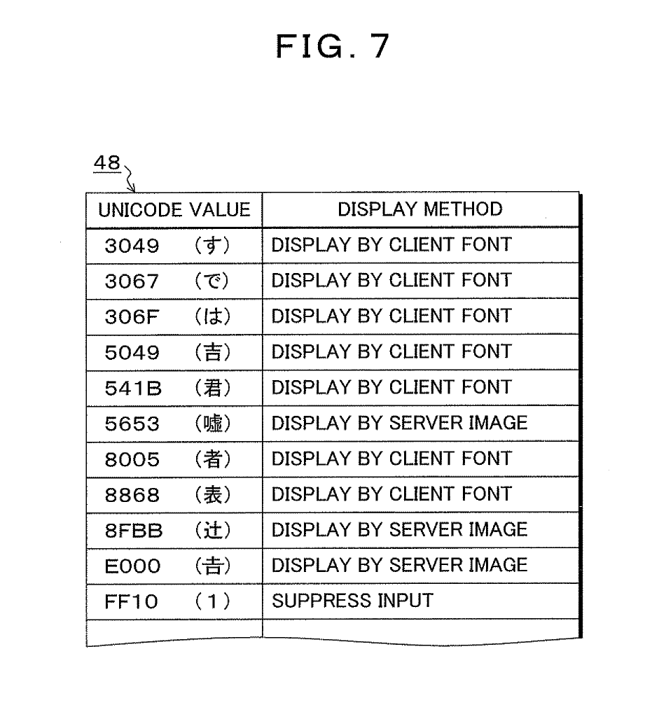

FIG. 7 is an explanatory diagram of the character form display method definition file 48, which is used in the present embodiment. In the character form display method definition file 48 of FIG. 7, it is comprised of Unicode values and display methods, all the code values of the unicodes which are managed by the client as Unicode values are registered, and, either one of character form display methods,
(1) display by a client font and
(2) display by a server image, is defined as a display method corresponding to each of the Unicode values. In this example, “DISPLAY BY SERVER IMAGE” is defined for the Unicode values “5653 (USO)”, “8FBB (TSUJI)”, and “E000 (YOSHI)”, and “DISPLAY BY CLIENT FONT” is defined for the Unicode values other than that. Note that (YOSHI) in the sentence of E000 is in the character form of FIG. 7 in practice. According to such definition of the display methods of the character form display method definition file 48, regarding display of the character image of each character code of the kana/kanji conversion candidates included in the candidate list transmitted to the client 16 from the server 10, whether a character is to be displayed according to the font file 94 of the client or a character image is to be acquired from the server 10 and displayed can be selected. In the character form display method definition file 48 of FIG. 7, specific display contents are described as the display methods; however, in an actual file, the display methods are set for example by a method of flag set in which a flag is reset to “0” when it is to be displayed by a client font, and the flag is set to “1” when it is to be displayed by a server image.

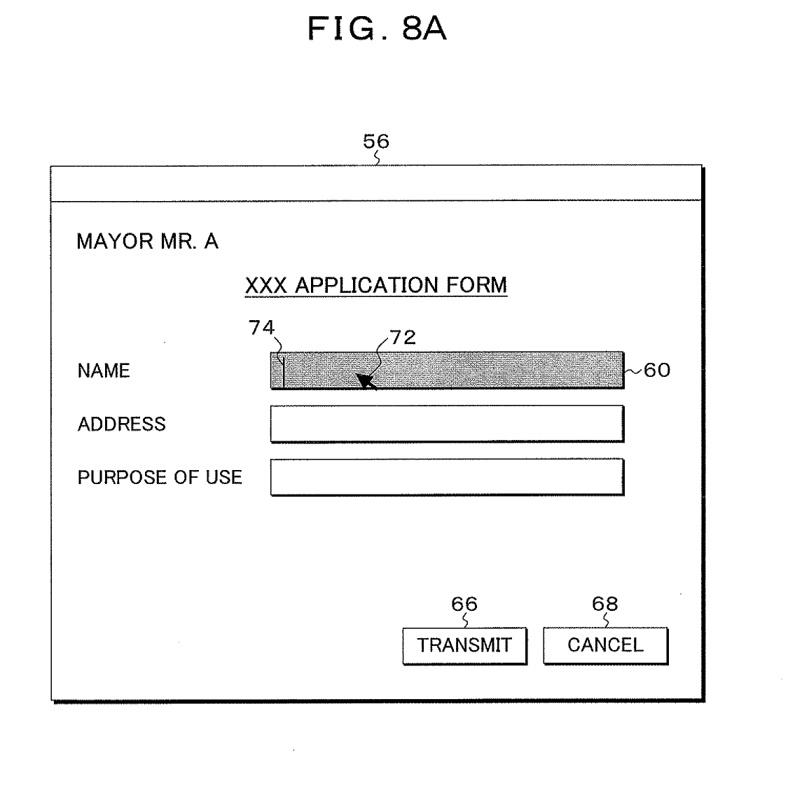

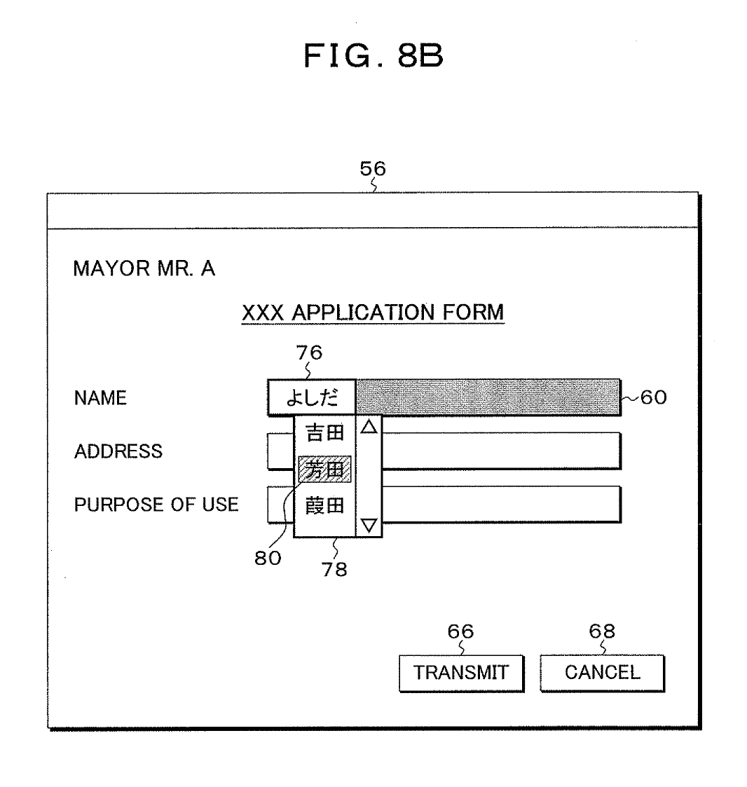

FIG. 8A shows a process which is performed when characters are to be input to the input area 60 of the name of the web page 56. In the web page 56, when “enter key” of the keyboard of the client 16 is pressed down, a specified color shown by gray is flashed in the top input area 60, and a caret 74 showing a character input position is processed. When a focus is placed on the input area 60, for example the kana/kanji conversion program IME (R) of Windows (R), which is provided by the OS of the client, is suppressed. Therefore, character input after the focus is placed on the input area 60 is processed by executing the program of the client execution module 88 downloaded from the server 10. The caret 74 in the focused input area 60 is displayed by an image or a border defined by CSS. When the position of a cursor 72 is clicked by a mouse, the caret 74 can be moved to the position of the cursor 72. Subsequently, as shown in FIG. 8B, when “YOSHIDA (in kana)” is input by key operations in the client 16, the input characters “YOSHIDA (in kana)” are displayed in a kana input window 76. Herein, the character input of Japanese on the keyboard of the client can use any of Roman character input, kana input, a soft keyboard, and handwritten input. When “conversion key” of the keyboard is pressed down for kanji conversion in the state in which the input into the kana input window 76 is finished, the reading information of the input character sequence “YOSHIDA (in kana)” is transmitted to the server 10 of FIG. 1, a candidate list (CSV/XML format) of Unicodes created through search of the kana/kanji conversion dictionary 28 by the kana/kanji conversion engine 26 of the server 10 is sent back, the display data of the candidate list including character images acquired from the server 10 is generated while referencing the character form display method definition file 48 by operations of the kana/kanji conversion processing unit 34, the character form display processing unit 36, and the function association processing unit 38, and [symbol] (YOSHIDA, YOSHIDA, YOSHIDA; in three different kanji character combinations)” is displayed in a list window 78 with the select function and the determination function attached thereto. Any of the candidates is selected by moving a focus 80 with respect to the candidate list displayed by the list window 78; the candidate is determined when “enter key” of the keyboard is pressed down at the candidate select information by the focus 80; and the list window 78 disappears when the kanji character sequence of the selected candidate is inserted and displayed in the kana input window 76 of the input area 60. As the process of the client execution module 88, the input area operation processing unit 40 generates Unicode character sequences from all character sequences of the input area 60 by using the Unicode text conversion processing unit 42 and puts that in the transmission buffer 90 according to the specification of the HTML platform. Then, when an end user presses the transmission button 66, the HTML platform transmits the contents of the transmission buffer 90 to the data reception processing unit 46 provided in the web application 24 of the server 10.

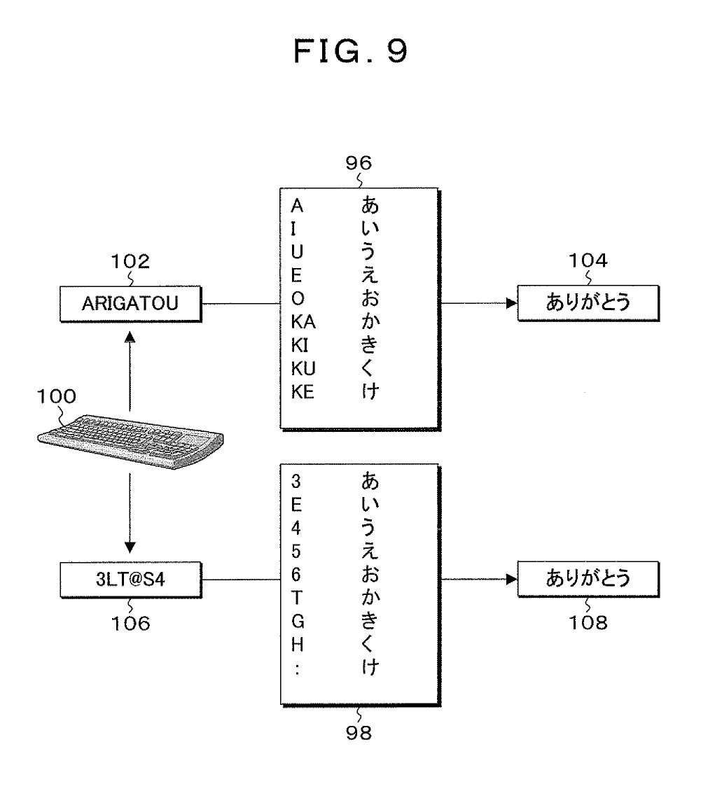

FIG. 9 is an explanatory diagram of a kana conversion process in the browser 18 of the client 16 which is performed when the web page 44 of the server 10 is opened and character input is performed, and it is a function realized by the kana/kanji conversion processing unit 34 of FIG. 6 downloaded from the server 10. In FIG. 9, when characters are to be input by the keyboard 100 of the client, Roman character or kana input is selected. When Roman character input is selected, a Roman character conversion table 96 becomes effective, Roman character input of typed key information 102 caused by input operations of alphabet keys of the keyboard 100 is given to the Roman character conversion table 96, and conversion output of an input kana character sequence 104 is obtained. On the other hand, when kana input is selected, a kana conversion table 98 becomes effective; when kana keys displayed on the keys of the keyboard 100 are input, the alphabet key input of typed key information 106 is obtained, and, when this is input to the kana conversion table 98, the conversion output of an input kana character sequence 108 can be obtained.

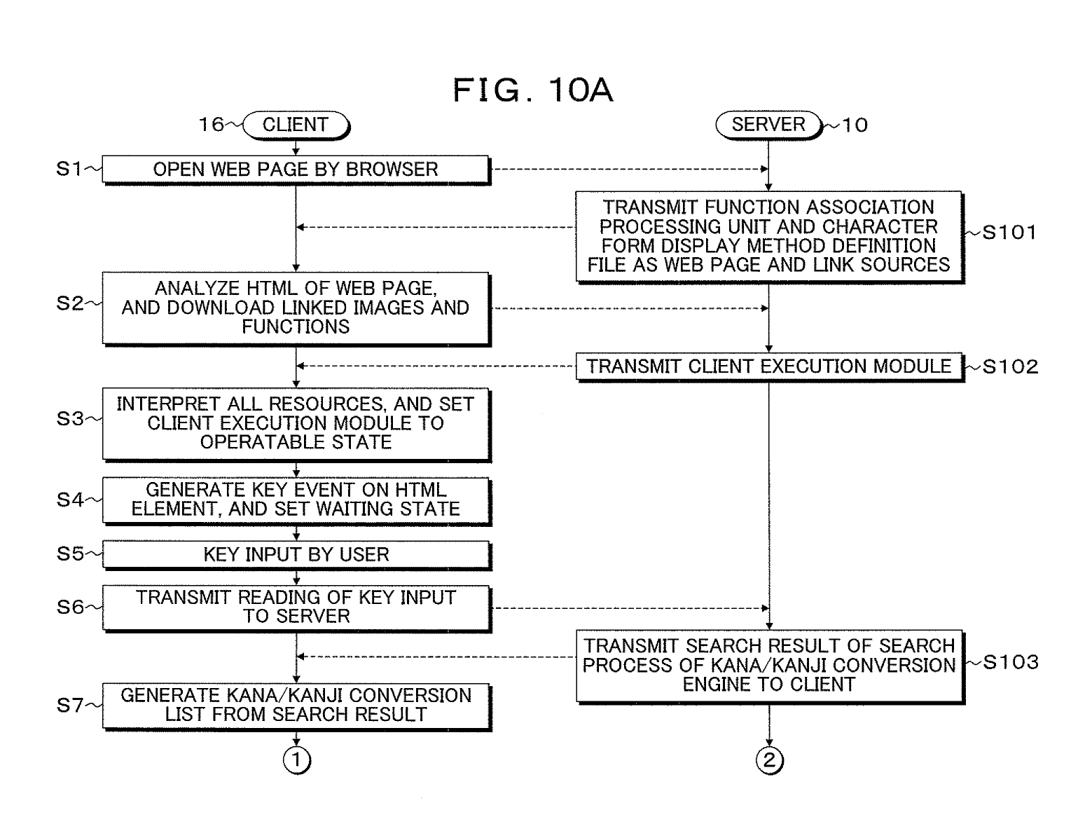

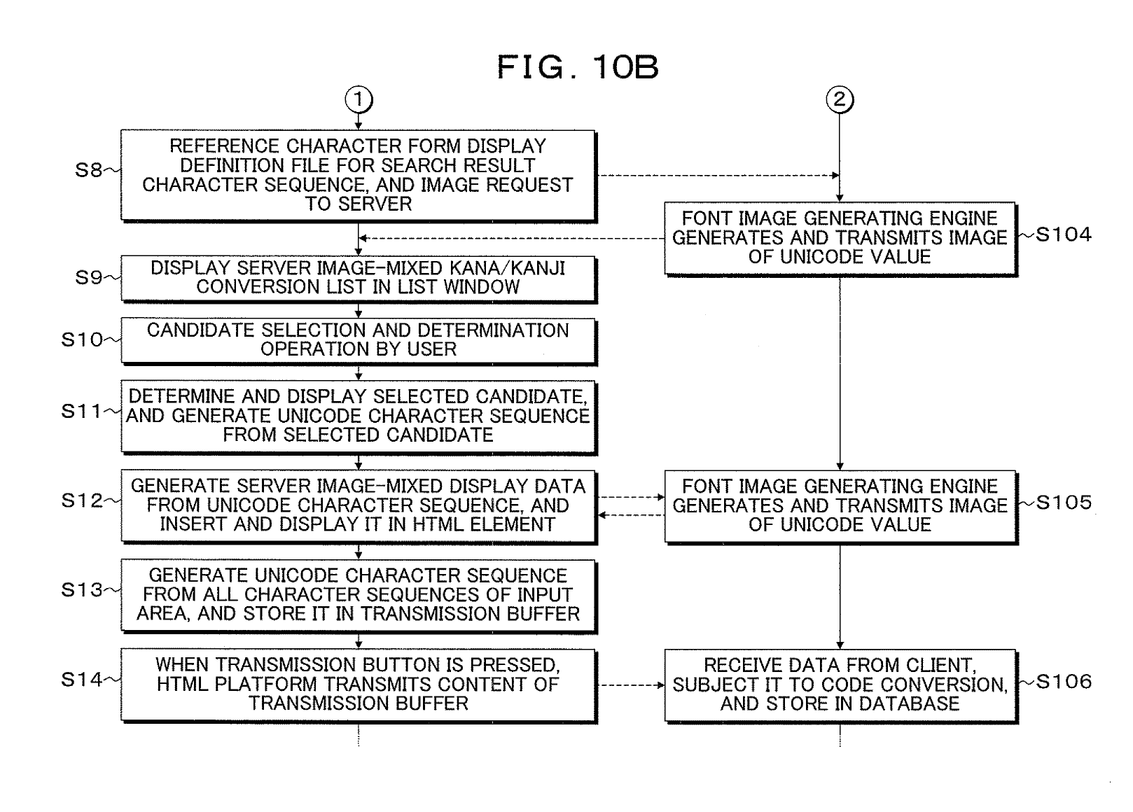

FIGS. 10A and 10B are time charts showing the character input editing process of the present embodiment in the server 10 and the client 16 of FIG. 1. First of all, in step S1, the end user of the client 16 opens the web page 44 of the web application 24 of the server 10 by the browser 18. In the server 10, in step S101, the web application 24 sends back the web page 44 including HTML and images. In the HTML, the function association processing unit 38 of the web application 22 and the character form display method definition file 48 of the web application 24 are linked. In addition, in accordance with the specification of the platform of the HTML, the data reception processing unit 46 is provided in the web application 24 corresponding to the data processing unit 50 which serves as a data transmission destination. In step S2, the browser 18 of the client 16 analyzes the HTML and downloads the linked images and the functions of the web application 22 from the server 10. In step S102, the web applications 20 and 22 of the server 10 sends back required images and functions. Particularly, the web application 22 transmits the entire client execution program including the kana/kanji conversion processing unit 34, the character form display processing unit 36, the function association processing unit 38, the input area operation processing unit 40, and the Unicode text conversion processing unit 42 in this initial stage. In step S3, the browser 18 of the client 16 finishes interpreting all the resources (including link resources), and the client execution program transmitted from the web application 22 of the server 10 to the client 16 builds the display/UI engine 45 as shown in FIG. 6 and attains an operatable state in the client 16. Subsequently, in step S4, the end user generates key and button events, which are activation events of the kana/kanji conversion processing unit 34, on the HTML element to which the client execution module of the web application 22 is associated. The kana/kanji conversion processing unit 34 at this point suppresses the kana/kanji conversion program IME (R) provided by the OS of the client 16 and generates a key event waiting state. Subsequently, in step S5, when the end user presses the conversion key after typing for example “yoshida”, the kana/kanji conversion processing unit 34 displays “YOSHIDA (in kana)” in a reading display area in step S6 and then transmits the reading “YOSHIDA (in kana)” to the kana/kanji conversion engine 26 provided in the web application 20 of the server 10 in step S6. In step S103, the kana/kanji conversion engine 26 provided in the web application 20 of the server 10 searches the kana/kanji conversion dictionary 28 according to the reading information transmitted from the client 16 and sends back a search result to the client 16 in CSV format data. For example, “E000, 7530” is returned. In step S7, in the client 16, the kana/kanji conversion processing unit 34 dynamically generates a candidate list, to which a select function and a determination function are attached, from the CSV format data of the candidate group transmitted from the server 10 and display it in a list window. When the search result character sequences are to be displayed, in step S8, the character form display processing unit 36 references the character form display method definition file 48, which is associated by the function association processing unit 38, and performs display by images, which are searched by the font image generating engine 30 provided in the web application 20 of the server 10, and text. For example, “<IMG src=“URL of E000 IMAGE” value=“E000”> DA (in kanji)” which is display data composed of an image element of an HTML source “<IMG src=“URL OF E000 IMAGE” value=“E000”>” and a text element “DA (in kanji)” is generated, and an HTML request based on the HTML source is transmitted to the font image generating engine 30 of the web application 20 provided in the server 10. In response to this, in step S104, the font image generating engine 30 provided in the web application 20 of the server 10 generates the image of the code value “E000” of Unicode from the font file 32 and sends it back. In step S9, the browser 18 of the client 16 displays images transmitted from the server 10, and a state in which all candidates are displayed in the list window is attained. Subsequently, in step S10, the end user presses a cursor key to select a determined candidate and presses a determination key. In response to this, in step S11, the select function dynamically generated by the kana/kanji conversion processing unit 34 and the kana/kanji conversion list reacts to the cursor key and performs a select display process such as candidate highlighting display, uses the Unicode text conversion processing unit 42 in response to a determination key, generates a Unicode character sequence from the current select candidates, and passes that to the input area operation processing unit 40. In step S12, the input area operation processing unit 40 generates image mixed display data from the passed Unicode character sequence by using the character form display processing unit 36, inserts the display data into a current caret position of the HTML element, and accordingly moves the caret. In generation of the display data in this case, as well as the candidate display of the kana/kanji list of step S7, the character form display processing unit 36 references the character form display method definition file 48, which is associated by the function association processing unit 38, and display is performed by the image and text transmitted from the font image generating engine 30 provided in the web application 20 of the server 10. Then, in step S13, the input area operation processing unit 40 generates Unicode character sequences from all character sequences in the input area by using the Unicode text conversion processing unit 42 and puts that in the transmission buffer 90 according to the specification of the HTML platform. Subsequently, in step S14, when the end user presses a transmission button, the HTML platform transmits the contents of the transmission buffer to the data reception processing unit 46 provided in the web application 24 of the server 10. In step S106, the data transmitted from the client 16 is received by the data reception processing unit 46 provided in the web application 24 of the server 10, passed to the data processing unit 50, converted from Unicode into JEF code by a code conversion unit 52, and stored in the database 54.

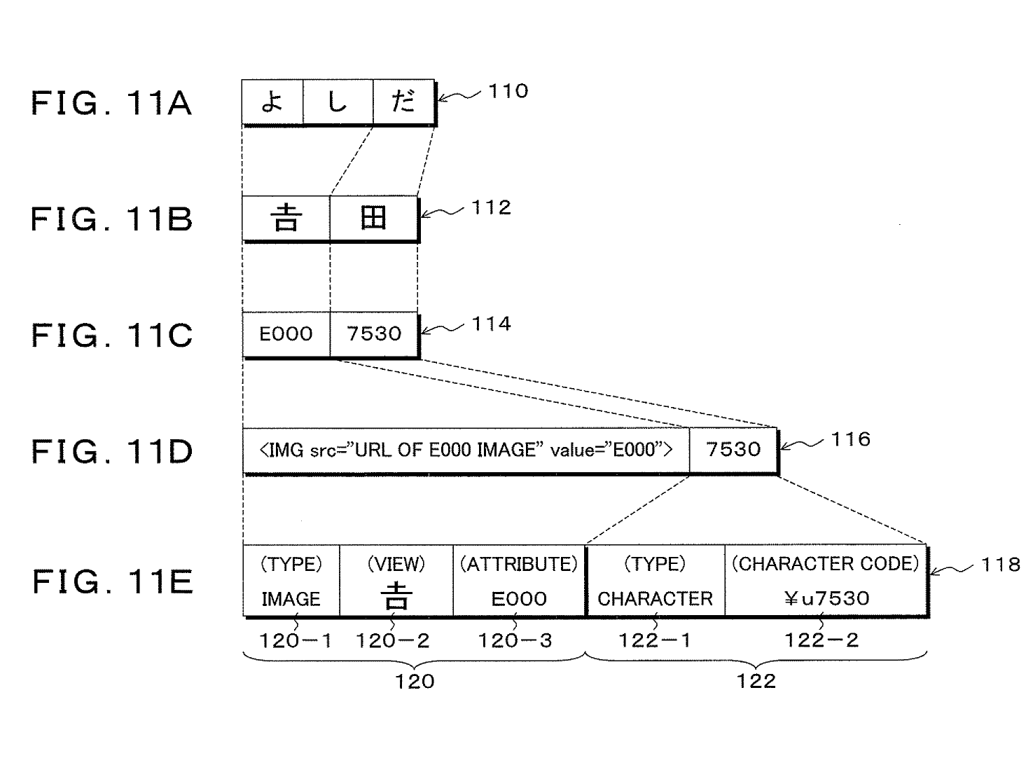

FIGS. 11 are explanatory diagrams showing, by data structures, the transition shown by the time chart of FIGS. 10A and 10B as a specific example from the reading information (kana information) input by keys until the display data is generated via kana/kanji conversion. “YOSHI (in kanji)” shown in FIGS. 11 is “YOSHI (in kanji)” having a long lower line.

FIG. 11A is the reading information 110 in the client 16 transmitted to the server 10 by key input of the user, wherein “YOSHIDA (in kana)” is input. The reading information 110 is converted into converted kanji 112 of FIG. 11B through search of the kana/kanji conversion dictionary 28 by the kana/kanji conversion engine 26 of the server 10 and transmitted to the browser 18 of the client 16 as a Unicode character sequence 114 of FIG. 11C. The browser 18 of the client 16 recognizes that the display method of the Unicode value “E000” is “DISPLAY BY SERVER IMAGE” and the display method of the Unicode value “7530” is “DISPLAY BY CLIENT FONT” by referencing the character form display method definition file 48 of FIG. 7 by the character form display processing unit 36 of the downloaded client execution module 88 of FIG. 6 and generates display data 116 of FIG. 11D. In the display data 116, with respect to the Unicode value “E000”, the HTML source “<IMG src=“URL of E000 IMAGE” value=“E000”>” for performing a URL request which serves as a character image request signal to the server is disposed; and, regarding the Unicode value “7530”, the Unicode value is disposed without change. The character form display processing unit 36 of the client 16 issues a URL request specifying the Unicode value “E000” from the client to the server 10 according to the HTML source of the display data 116, acquires a character image generated in search of the font file 32 by the font image generating engine 30 of the server 10, and generates display data 118 of FIG. 11E. The display data 118 is an element sequence of an image element 120 and a text element 122. In the image element 120, in the case of an HTML document, a data type 120-1 is “IMAGE”, a server image is disposed in a view 120-2, and the Unicode “E000” is disposed as an attribute 120-3. In display of the image element 120, a character sequence insertion API of an editor provided by the OS of the client is suppressed to display the server image of the view 120-2. In the case of the HTML document, the text element 122 is a display element of a text format having a data type 122-1 of “CHARACTER” and the Unicode value “7530” as a character code 122-2 (wherein, “¥” is a symbol for converting “7530” into a character as a unicode). In the display of the text element 122, when “¥u7530” is passed to the character sequence insertion API provided by the HTML platform of the client, a character image is generated and displayed by searching the font file 94 of the client 16 by the function of the editor.

FIG. 12 is a flow chart of a server process in the server 10 of the present embodiment which, at the same time, shows a processing program in the server 10. In FIG. 12, a web page acquisition request from the client is checked in step S1; and, when there is the acquisition request, the process proceeds to step S2, wherein the web application 24 sends back the web page 44 including HTML and images. In the HTML, the function association processing unit 38 of the web application 22 and the character form display method definition file 48 of the web application 24 are linked. In addition, in accordance with the specification of the platform of the HTML, the data reception processing unit 46 is set in the web application 24 corresponding to the data processing unit 50, which serves as a data transmission destination. Subsequently, a download request of link sources based on analysis of the HTML of the client is checked in step S3; and, when there is a download request, in step S4, the web applications 20 and 22 transmit, as link resources, images and the client execution module serving as functions, which are required. The client execution module includes all of the kana/kanji conversion processing unit 34, the character form display processing unit 36, the function association processing unit 38, the input area operation processing unit 40, and the Unicode text conversion processing unit 42. Subsequently, when reception of reading information and a dictionary type is determined in step S5 along with character key input in the client, the process proceeds to step S6, wherein the kana/kanji conversion dictionary 28 is searched according to the reading transmitted from the client 16 by the kana/kanji character conversion engine 26 provided in the web application 20, and the search result is transmitted to the client 16 in CSV format data. Subsequently, when an image request from the client 16 specifying a Unicode value is determined in step S7, the process proceeds to step S8, wherein the character image of the unicode is generated from the font file 32 by the font image generating engine 30 of the web application 20 and transmitted. Such processes of steps S1 to S8 are repeated until there is a stop order in step S9. Note that, in the web application 24 of the server 10, since the HTML platform sends the contents of the transmission buffer when character input of an HTML element is finished in the client, the processes in which it is received by the data reception processing unit 46, passed to the data processing unit 50, converted from Unicode into JEF code by the code conversion unit 52, and stored in the database 54 are executed.

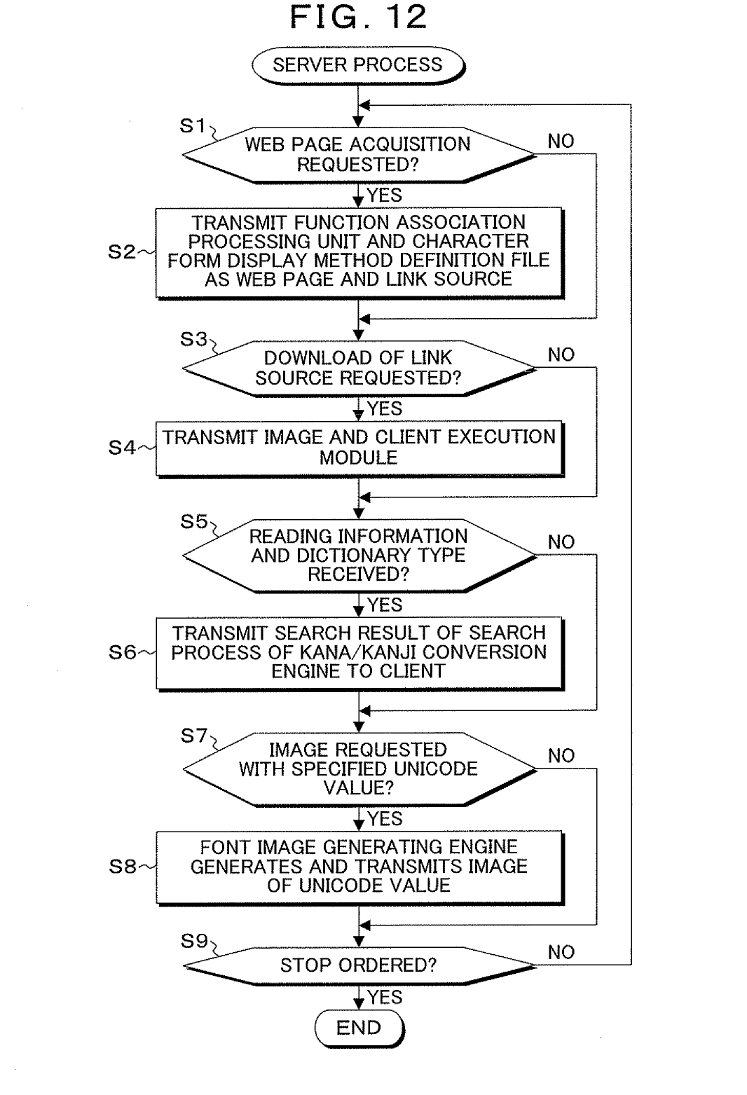

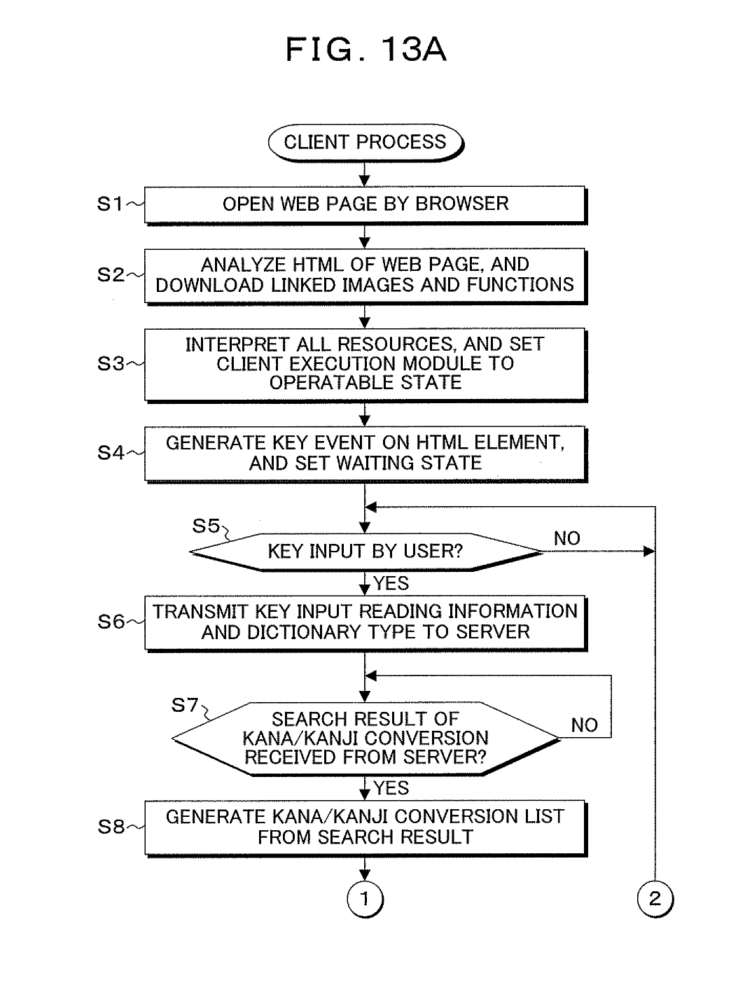

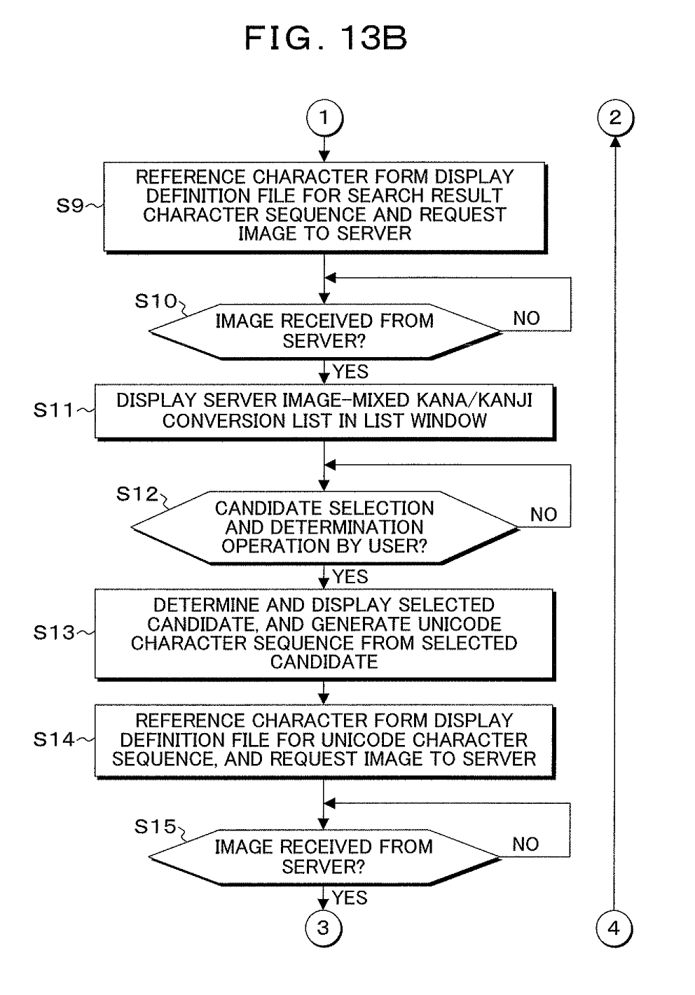

FIGS. 13A, 13B and 13C are flow charts of a client process executed in the browser 18 of the client 16 from the server 10. At the same time, the flow chart also show a processing procedure of the program which realizes the kana/kanji conversion processing unit 34, the character form display processing unit 36, the function association processing unit 38, the input operation processing unit 40, and the Unicode text conversion processing unit 42 of the client execution module 88 which is downloaded from the server 10 to the client and executed therein.

In FIGS. 13A and 13B, in step S1, the end user of the client 16 opens the web page 44 of the web application 24 of the server 10 by the browser 18. With respect to this, the web page 44 including HTML and images is received from the server 10, wherein the function association processing unit 38 and the character form display method definition file 48 of the web application 24 are linked in the HTML. Subsequently, in step S2, the HTML of the received web page is analyzed, and the linked images and functions are downloaded from the server 10. Through this download, the required images and functions can be received from the server 10, and the received functions include the kana/kanji conversion processing unit 34, the character form display processing unit 36, the function association processing unit 38, the input area operation processing unit 40, and the Unicode text conversion processing unit 42 as the client execution module. Subsequently, in step S3, the browser 18 finishes interpreting all the resources (including link resources), and the client execution module received from the server 10 attains an operatable state in the client 16. Subsequently, in step S4, the end user generates key and button events, which are activation events of the kana/kanji conversion processing unit 34, on the HTML element to which the client execution module of the web application 22 is associated. At this point, the kana/kanji conversion processing unit 34 suppresses the kana/kanji conversion program IME (R) provided by the OS of the client 16 and attains a key event waiting state. When a conversion key is pressed after the end user typed in step S5; in step S6, the kana/kanji conversion processing unit 34 displays reading in a reading display area and then transmits the reading information (kana information) and a dictionary type to the server 10. With respect to this, the kana/kanji conversion engine 26 of the server 10 searches the kana/kanji conversion dictionary 28 according to the reading and sends back the search result in CSV format data to the client 16; therefore, when reception of the search result is determined in step S7, the process proceeds to step S8, wherein a kana/kanji conversion list, to which a select function and a determination function are attached, is dynamically generated from the CSV format data of the received search result. Subsequently, in order to display search result character sequences, in step S9, the character form display processing unit 36 references the character form display method definition file 48, which is associated by the function association processing unit 38, and, when server images are recognized, requests the images to the sever 10. When the server images generated by the font image generating engine 30 of the server 10 are received in response to the image request in step S10, the process proceeds to step S11, wherein the state in which a kana/kanji conversion list displaying all server-image-mixed candidates is displayed in a list window is attained. Subsequently, when it is determined in step S12 of FIG. 13C that the end user has selected a determined candidate by pressing a cursor key and pressed a determination key, the process proceeds to step S13, wherein the select function dynamically generated by the kana/kanji conversion processing unit 34 and the kana/kanji conversion list reacts to the cursor key and performs a select display process such as candidate highlighting display, and a Unicode character sequence is generated from the current select candidates by using the Unicode text conversion processing unit 42 in response to the determination key and passed to the input area operation processing unit 40. Subsequently, it proceeds to the processes of steps S14 to S16, wherein the input area operation processing unit 40 generates image-mixed display data from the passed Unicode character sequence by using the character form display processing unit 36, the display data is inserted to a current caret position in the HTML element, and the caret is accordingly moved. In generation of the display data in this case, the character form display processing unit 36 references the character form display method definition file 48, which is associated by the function association processing unit 38, in step S14, and requests an image to the server when the display method is server image display; and, when image reception from the server 10 is determined in step S15, image-mixed display data is generated from a Unicode character sequence, and the display data is inserted to the current caret position in step S16. Subsequently, in step S17, the input area operation processing unit 40 generates Unicode character sequences from all character sequences of the input areas by using the Unicode text conversion processing unit 42 and puts that in the transmission buffer according to the specification of the HTML platform. Subsequently, presence of a copy and paste operation in the client is checked in step S18; and, when the copy and paste operation is performed, the copy 3 and paste process of step S19 is executed. Subsequently, when an on operation of the transmission button by the end user is determined in step S20, in step S19, the HTML platform transmits the contents of the transmission buffer to the data reception processing unit 46 provided in the web application 24 of the server 10 and terminates the process.

Another embodiment of the present invention is characterized in the client 16, the JFE data read from the database 54 is converted into Unicode by the data processing unit 50 when the web page 44 of the server 10 is opened by the client 16, it is transmitted to the client 16 in the HTML format, and text-element-mixed display data using an image element acquired a character image from the server and having a character code as an attribute and a text format client font is generated and displayed in the client 16. In such a case, in the server 10, the font image generating engine 20 and the font file 32 of the web application 20 are used. Meanwhile, as the functions of the client execution module 88 downloaded to the client as shown in FIG. 6, the character form display method definition file 48 can be referenced by using the character form display processing unit 36 and the function association processing unit 38 among them. More specifically, when the font image generating engine (character image conversion unit) 20 of the server 10 receives a character image request signal of Unicode from the client 16, the character image of the received Unicode or the information required for generating the character image is transmitted to the client 16 to display the character image. On the other hand, when the server 10 receives a web page acquisition request from the client 16, the character form display method definition file 48 and the client execution module 88 are downloaded together with the web page; and, when the character form display processing unit 36 therein is to display a character sequence of the HTML document, the character form display method definition file 48 is referenced in accordance with association of the function association processing unit 38, and whether each character is to be displayed by a server image or to be displayed by a client font is determined. Then, in the case of the server image display, a character image request signal is transmitted to the server to acquire it, display data mixed with text, i.e., display data (element sequence) in which a text format text element and an image element having a character code as an attribute are mixed is generated and displayed.

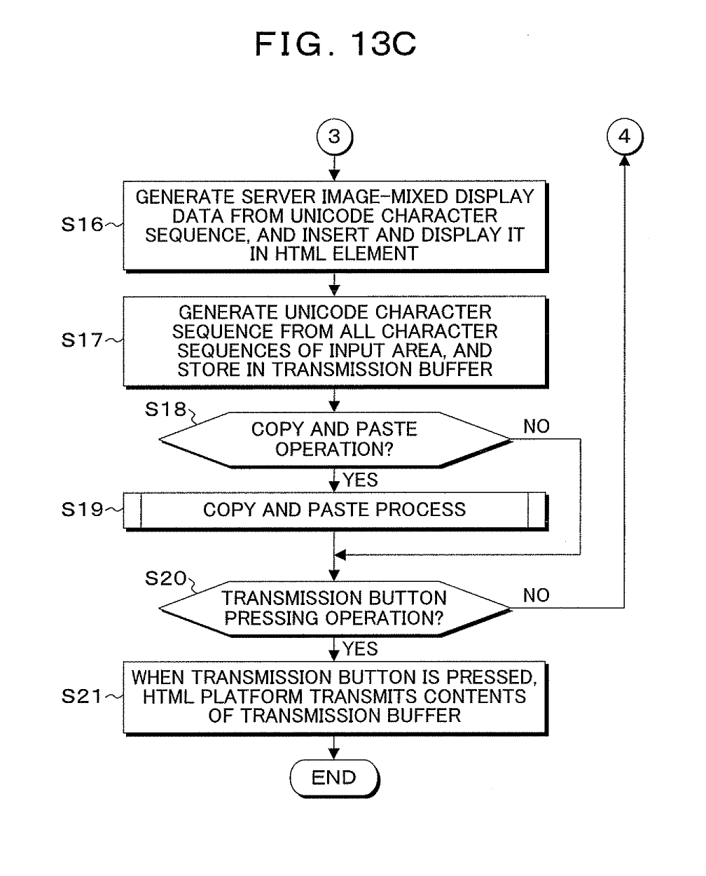

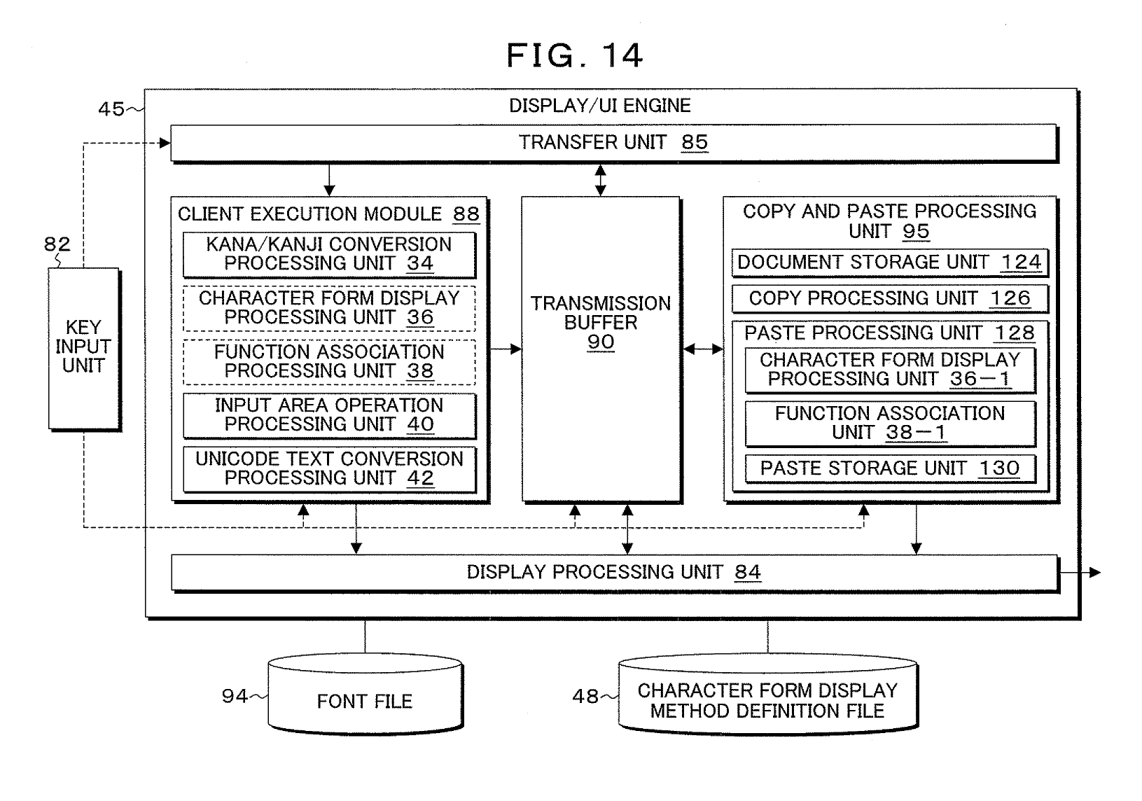

FIG. 14 is a block diagram showing a functional configuration of a copy and paste process in the present embodiment, and it is realized as functions of the display/UI engine 45 shown in FIG. 6 which is realized by the program downloaded from the server 10 and executed by the browser 18 of the client 16. In FIG. 14, in the display/UI engine 45, in addition to the display processing unit 84, the transfer unit 85, the client execution module 88, and the transmission buffer 90, the copy and paste processing unit 95 is provided as one function of the edit processing unit 92 of FIG. 6. The client execution module 88 is a function downloaded from the server 10 and includes the kana/kanji conversion processing unit 34, the character form display processing unit 36, the function association processing unit 38, the input area operation processing unit 40, and the Unicode text conversion processing unit 42. Among these, the functions of the character form display processing unit 36 and the function association processing unit 38 are shown by dotted lines since they are used in the copy and paste process. In addition, with respect to the display/UI engine 45, the key input unit 82 and the character form display method definition file 48 downloaded from the web application 24 of the server 10 are provided. When the browser 18 of the client 16 finishes interpreting all the resources (including link resources) downloaded from the server 10, the downloaded client execution module 88 attains an operatable state in the client 16. In the copy and paste processing unit 95, a document storage unit 124, a copy processing unit 126, and a paste processing unit 128 are provided. Furthermore, in the paste processing unit 128, a character form display processing unit 36-1, a function association processing unit 38-1, and a paste storage unit 130 are provided. Among these, the character form display processing unit 36-1 and the function association processing unit 38-1 mean that the functions of the character form display processing unit 36 and the function association processing unit 38 shown by dotted lines present in the client execution module 88 are executed by the paste processing unit 128. The document storage unit 124 stores, in a document, as a type of a document element, an element sequence in which a text element which is a document element for text dependent on the HTML platform and an image element which has a server character image acquired from the server 10 in a view, has a Unicode value as an attribute, and is dependent on the HTML platform are mixed. When a copy operation on the screen displaying the document stored by the document storage unit 124 is determined, the copy processing unit 126 reads copy source character sequence data from the element sequence including the text element and the image element stored in the document of the copy source and stores it in a clipboard which functions as a copy buffer. When a paste operation is determined subsequent to the copy operation, the paste processing unit 128 generates an element sequence including the text element and the image element from the copy source character sequence data stored in the clipboard and inserts it into a document of a paste destination. In the process of the paste processing unit 128, the character form display processing unit 36-1 references the character form display method definition file 48, which is associated by the function association unit 38-1 and has the contents shown in FIG. 7, for each unicode of the copy source character sequence data stored in the clipboard and determines whether it is client font display or server image display. Herein, when client font display is determined, a text element wherein the value of the unicode serves as a code value without modification is generated. Meanwhile, when server image display is determined, a character image request signal including the unicode value, for example, a URL request specifying the unicode value is transmitted to the server 10 so as to acquire a server character image by searching the font file 32 by the font image generating engine 30 of the server 10, an image element in which the acquired server character image is disposed in the view and the Unicode value is provided as an attribute is generated. The paste storage unit 130 stores the element stream generated by the character form display processing unit 36-1 in which the text element and the image element are mixed. Note that, when the copy and paste processing unit 95 the present embodiment operates, copy and paste function provided by the OS of the client 16 are suppressed.

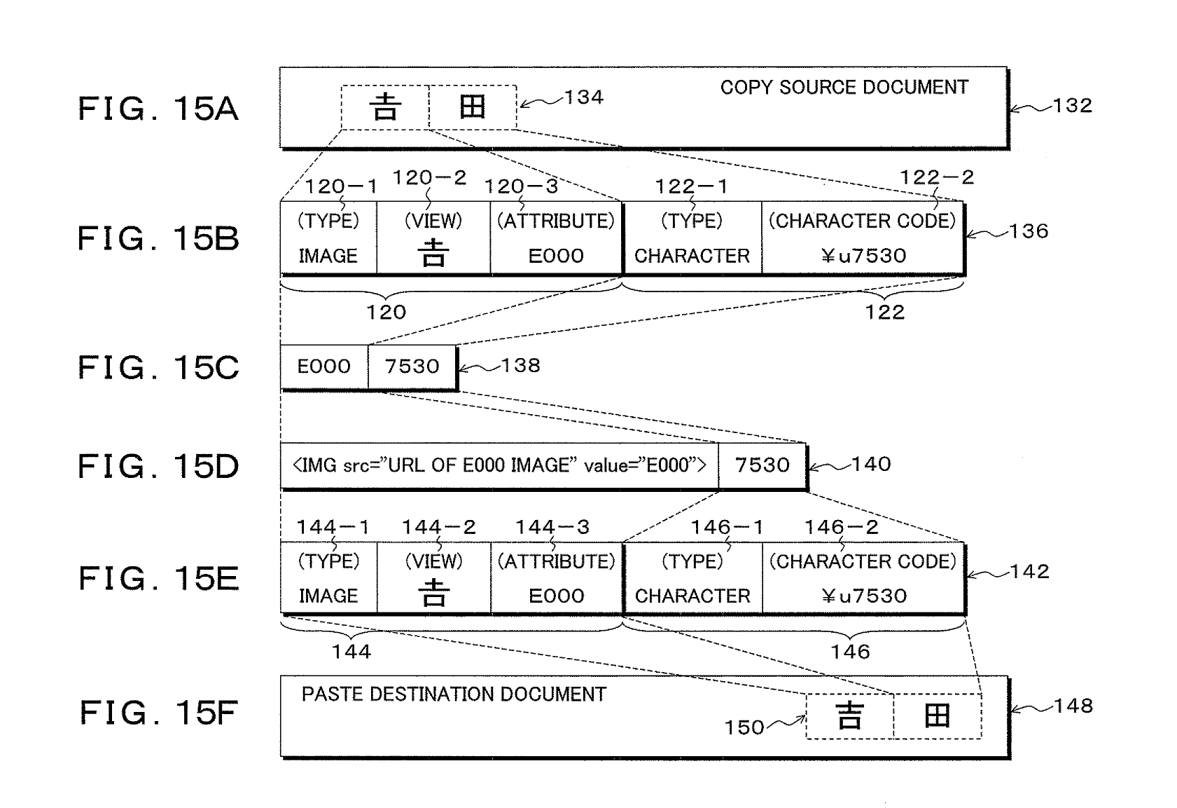

FIGS. 15A to 15F show explanatory diagrams showing transition of the copy and paste process of the present embodiment by data structures.

FIG. 15A shows a copy source document 132, wherein character sequence data of an element sequence in which a text element and an image element are mixed is stored, and two characters at a copy position 134 are subjected to a copy operation. The two characters at the copy position 134 are, as shown in FIG. 15B, an element sequence 136 of the image element 120 and the text element 122. In the image element 120, in the case of an HTML document, the data type 120-1 is “IMAGE”, the server image is disposed in the view 120-2, and the unicode “E000” is disposed as the attribute 120-3. In display of the image element 120, a character sequence insertion API of an editor provided by the OS of the client is suppressed to display the server image of the view 120-2. In the case of the HTML document, the text element 122 is a display element of a text format having the data type 122-1 of “CHARACTER” and the Unicode value “7530” as the character code 122-2 (wherein, “¥u” is a symbol for converting “7530” into a character as a unicode). In the display of the text element 122, when “¥u7530” is passed to the character sequence insertion API of the editor provided by the HTML platform of the client, a character image is generated and displayed by searching the font file 94 of the client 16 by the function of the editor.

FIG. 15C shows copy source character sequence data 138 generated from the element sequence 136 by reading the unicode, and it is stored in the clipboard which functions as a copy buffer. The unicode of the image element 120 can be read from the attribute 120-3 thereof.

FIG. 15D shows copy source display data 140 which is generated from the copy source character sequence data 138 of the clipboard upon the paste process by referencing the character form display method definition file 48. In this case, the unicode “E000” of the copy source character sequence data 138 is determined as server image display by referencing the character form display method definition file 48, an HTML source “<IMG src=“URL of E000 IMAGE” value=“E000”>” for performing URL request serving as a character image request signal with respect to the server 10 is disposed, and an unchanged Unicode character value is disposed for “¥u7530”. The character form display processing unit 36-1 of the paste processing unit 128 issues a URL request specifying the Unicode value “E000” to the server 10 according to the HTML source of the copy source display data 140, acquires a character image generated by searching the font file 32 by the font image generating engine 30 of the server 10, and generates an image element 144 in an element sequence 142 of FIG. 15E. A text element 146 is generated wherein the value of the unicode “7530” is unchanged. In the image element 144, as well as the element sequence of the copy source of FIG. 15B, a data type 144-1 is “IMAGE”, the server image is disposed in a view 144-2, and the unicode “E000” is disposed as an attribute 144-3. Similarly, also in the text element 146, a data type 146-1 is “CHARACTER”, and the Unicode character “¥u7530” is disposed in a character code 146-2. The element sequence 142 generated as shown in FIG. 15E is inserted into a paste position 150 of a paste destination document 148, which is specified by a paste operation, as shown in FIG. 15F.

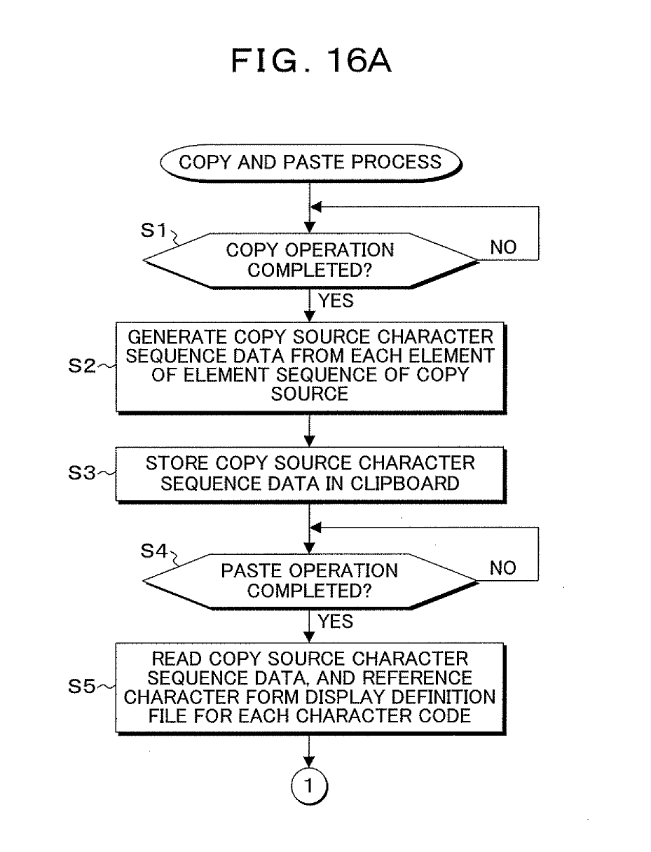

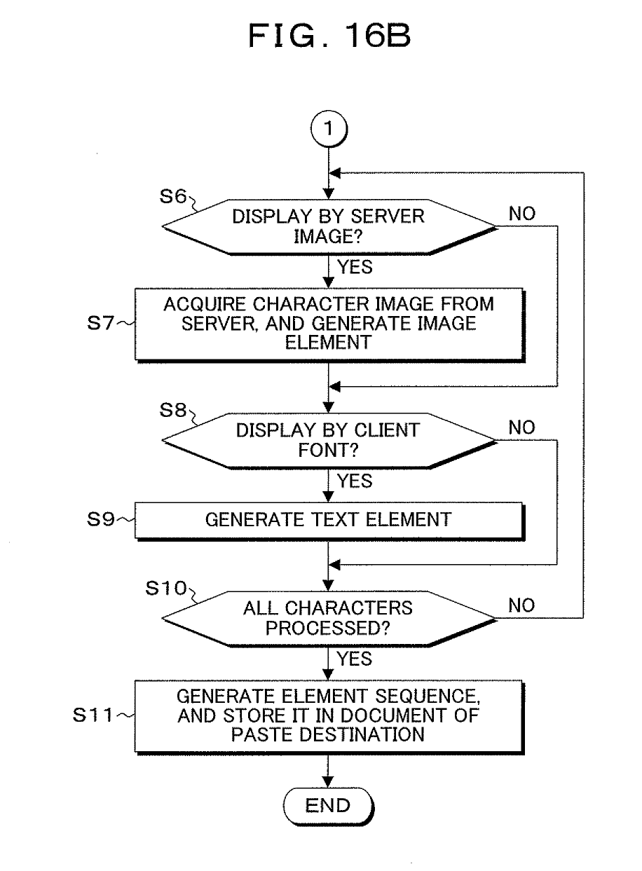

FIGS. 16A and 16B are flow charts of the copy and paste process in the present embodiment, wherein the contents of the flow chart represent a copy and paste processing program at the same time. In FIGS. 16A and 16B, when completion of a copy operation by a user on the display screen of a document is determined in step S1, the process proceeds to step S2, wherein copy source character sequence data is generated by reading elements, i.e., an image element and a text element, in an element sequence at a copy position in the document of the copy source, and it is stored in the clipboard in step S3. Subsequently, when completion of the paste operation by the user is determined, the process proceeds to step S5, wherein copy source character sequence data is read from the clipboard, and the character form display method definition file 48 is referenced for each character code so as to acquire a display method. When the display method is display by a server image in step S6, the process proceeds to step S7, wherein a URL request based on the HTML source specifying a character code is transmitted to the server 10 so as to acquire the character image from the server 10, the character image is disposed in the view, and an image element having a character code value as an attribute is generated. Meanwhile, when the display method is client font display in step S8, a text element in which a character code value is used as a value without change is generated in step S9. When element generation of all the characters is determined in step S10, an element sequence in which the elements are disposed is generated and inserted to a paste position of the document of the paste destination in step S11. Note that, the above described embodiments take Japanese supporting ones as examples; however, they can be applied without modification to an arbitrary language as long as the language requires input of reading information of character sequences and character conversion as well as Japanese. Examples of such language include Chinese character conversion, Korean character conversion, etc. which require conversion to kanji in response to reading input, and they can be applied to character input editing of such languages other than Japanese. Specifically, the present invention can be applied without modification to the languages which require IME (R) in Windows (R). Moreover, in the above described embodiments, reading information is converted into kanji character codes of Unicode in the server; however, character codes other than that of Unicode may be used. Moreover, with respect to the HTML platform, the above described embodiments take the element type dependent on the HTML platform as an example; however, element types dependent on respective platforms are employed for, for example, XML, Java (R), Windows (R) programming other than that. Furthermore, the present invention includes arbitrary modifications that do not impair the object and advantages thereof and is not limited by the numerical values shown in the above described embodiments.

What is claimed is:

1. A computer-readable storage medium which stores a program characterized by causing a computer of a client connected to a server via a network to execute
a document storage step in which, as a type of an element sequence, an element sequence in which a text element which is an element sequence for text and an image element which has a server character image acquired from the server as a view and has a character code value as an attribute are mixed is stored in a document;
a copy processing step in which, when a copy operation is determined on a screen, character codes are read from the text element and the image element stored in the document of a copy source, and copy source character sequence data is generated and stored in a copy buffer; and
a paste processing step in which, when a paste operation is determined subsequent to the copy operation, an element sequence including the text element and the image element is generated from the copy source character sequence data stored in the copy buffer and inserted into a document of a paste destination.

2. The storage medium according to claim 1, wherein the paste processing step is characterized by causing the computer of the client to execute
a character form display processing step in which character form display method definition information registered in advance is referenced for each character code of the copy source character sequence stored in the copy buffer, a text element in which the character code serves as a code value without change is generated when client font display is determined, and an image element in which a sever character image acquired by transmitting a character image request signal including the character code to the server is disposed in a view and a character code value is provided as an attribute is generated when server image display is determined; and
a paste storage step in which an element stream in which the text element and the image element generated in the character form display processing step are mixed is stored in the document of the paste destination.

3. The storage medium according to claim 2, characterized in that the character form display method definition information and a program which executes the character form display processing step are downloaded from the server and executed by the client.

4. The storage medium according to claim 1, characterized in that the text element and the image element have a data structure dependent on a platform in which the document is present.

5. The storage medium according to claim 1, characterized in that the character code is a unicode.

6. A copy and paste processing method of a client connected to a server via a network, the copy and paste processing method characterized by executing
a document storage step in which, as a type of an element sequence, an element sequence in which a text element which is an element sequence for text and an image element which has a server character image acquired from the server as a view and has a character code value as an attribute are mixed is stored in a document;
a copy processing step in which, when a copy operation is determined on a screen, character codes are read from the text element and the image element stored in the document of a copy source, and copy source character sequence data is generated and stored in a copy buffer; and
a paste processing step in which, when a paste operation is determined subsequent to the copy operation, an element sequence including the text element and the image element is generated from the copy source character sequence data stored in the copy buffer and inserted into a document of a paste destination.

7. The copy and paste processing method according to claim 6, wherein the paste processing step is characterized by causing the computer of the client to execute
a character form display processing step in which character form display method definition information registered in advance is referenced for each character code of the copy source character sequence stored in the copy buffer, a text element in which the character code serves as a code value without change is generated when client font display is determined, and an image element in which a sever character image acquired by transmitting a character image request signal including the character code to the server is disposed in a view and a character code value is provided as an attribute is generated when server image display is determined; and
a paste storage step in which an element stream in which the text element and the image element generated in the character form display processing step are mixed is stored in the document of the paste destination.

8. The copy and paste processing method according to claim 7, characterized in that the character form display method definition information and a program which executes the character form display processing step are downloaded from the server and executed by the client.

9. The copy and paste processing method according to claim 6, characterized in that the text element and the image element have a data structure dependent on a platform in which the document is present.

10. The copy and paste processing method according to claim 6, characterized in that the character code is a unicode.

11. A copy and paste processing device of a client connected to a server via a network, the copy and paste processing device characterized by having
a document storage unit which, as a type of an element sequence, stores an element sequence in which a text element which is an element sequence for text and an image element which has a server character image acquired from the server as a view and has a character code value as an attribute are mixed in a document;
a copy processing unit which, when a copy operation is determined on a screen, reads character codes from the text element and the image element stored in the document of a copy source, generates copy source character sequence data, and stores the data in a copy buffer; and
a paste processing unit which, when a paste operation is determined subsequent to the copy operation, generates an element sequence including the text element and the image element from the copy source character sequence data stored in the copy buffer and inserts the sequence into a document of a paste destination.

12. The copy and paste processing apparatus according to claim 11, wherein the paste processing step is characterized in that,
a character form display processing unit which references character form display method definition information registered in advance for each character code of the copy source character sequence stored in the copy buffer, generates a text element in which the character code serves as a code value without change when client font display is determined, and disposes an image element in which a sever character image acquired by transmitting a character image request signal including the character code to the server in a view and provides a character code value as an attribute is generated when server image display is determined; and
a paste storage unit which stores an element stream in which the text element and the image element generated in the character form display processing step are mixed in the document of the paste destination.

13. The copy and paste processing apparatus according to claim 12, characterized in that the character form display device definition information and a program which constitutes a function of the character form display processing unit are downloaded from the server and executed by the client.

14. The copy and paste processing apparatus according to claim 11, characterized in that the text element and the image element have a data structure dependent on a platform in which the document is present.

15. The copy and paste processing apparatus according to claim 11, characterized in that the character code is a unicode.
